(19) United States
(12) Patent Application Publication
(10) Pub. No.: US 2017/0329644 A1
(43) Pub. Date: Nov. 16, 2017

(54) COMPUTER-READABLE RECORDING MEDIUM HAVING STORED THEREIN PROGRAM, INFORMATION PROCESSING APPARATUS, INFORMATION PROCESSING SYSTEM, AND METHOD FOR PROCESSING INFORMATION

(71) Applicant: FUJITSU LIMITED, Kawasaki-shi (JP)

(72) Inventor: Keisuke Imamura, Setagaya (JP)

(73) Assignee: FUJITSU LIMITED, Kawasaki-shi (JP)

(21) Appl. No.: 15/488,039

(22) Filed: Apr. 14, 2017

(30) Foreign Application Priority Data
May 16, 2016 (JP) 2016-098258

(51) Int. Cl. G06F 9/50; G06F 9/455

(52) U.S. Cl. CPC G06F 9/5044; G06F 9/45504

(57) ABSTRACT

An information processing apparatus includes a processor configured to: cause a plurality of processor cores (threads) to execute processes (packet processes) of a plurality of virtual functions (VNFs) each including one or more virtual interfaces (VNICs); and allocate the plurality of virtual functions to the plurality of processor cores in a unit of each of the plurality of virtual functions such that the one or more of the virtual interfaces included in each of the plurality of virtual functions belong to one of the plurality of processor cores. This enable to ensure processing capability in a unit of a virtual function.

### CROSS-REFERENCE TO RELATED APPLICATION

This application is based upon and claims the benefit of priority of the prior Japanese Application No. 2016-98258 filed on May 16, 2016 in Japan, the entire contents of which are hereby incorporated by reference.

### FIELD

The embodiment discussed herein relates to a non-transitory computer-readable recording medium having stored therein a program, an information processing apparatus, an information processing system, and a method for processing information.

### BACKGROUND

In recent years, Open Source Software (OSS) that carries out packet processing in a polling scheme has been provided. This accompanies adoption of a polling scheme that can carry out packet processing faster than an interruption scheme in various systems.

In addition, development in virtualization techniques has enhanced application of a technique of Network Functions Virtualization (NFV) that achieves the network function such as a router, a firewall, and a load balancer with Virtual Machines (VMs) to a network system.

Therefore, a recent information processing system has used a technique that process packets in a polling scheme and an NFV technique in conjunction with each other.

Such an information processing system is provided with multiple network functions on a single hardware device and adopts a multitenant architecture. A service provider desires to provide various services on a single hardware and works various types of Virtualized Network Functions (VNFs) having various capabilities on a single hardware device.

[Patent Document 1] WO2015/141337

[Patent Document 2] WO2014/125818

In processing packets in a polling scheme, if the packet processing is unevenly loaded on a certain VNF, the throughput of the remaining VNFs may be declined. Providing an NFV service under multitenant environment needs virtual division of a resource to enhance the independency of each tenant. This arises a problem of ensuring a capability of processing packet in each VNF under multitenant environment in a polling scheme.

### SUMMARY

The program of this embodiment causes a computer to execute the following processes of:

(1) causing a plurality of processor cores to execute processes of a plurality of virtual functions each including one or more virtual interfaces; and
(2) allocating the plurality of virtual functions to the plurality of processor cores in a unit of each of the plurality of virtual functions such that the one or more of the virtual interfaces included in each of the plurality of virtual functions belong to one of the plurality of processor cores.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram schematically illustrating an example of the configuration and the operation of an NFV system adopting a polling scheme;

FIG. 2 is a diagram illustrating a correlation among a polling thread to carry out packet transmission and reception processing, a Network Interface Card (NIC), and a Central Processing Unit (CPU) core in the example of FIG. 1;

FIG. 3 is a diagram illustrating an operation of an NFV system of FIG. 1;

FIG. 4 is a diagram illustrating an operation of an NFV system of FIG. 1;

FIG. 5 is a block diagram schematically illustrating an operation of an NFV system of FIG. 1;

FIGS. 6 and 7 are flow diagrams illustrating the detailed procedural steps performed by an NFV system of FIG. 1;

FIG. 8 is a block diagram schematically illustrating hardware configurations and functional configurations of an information processing system and an information processing apparatus according to a present embodiment;

FIG. 9 is a block diagram schematically illustrating the overview of an operation of an information processing system of FIG. 8;

FIGS. 10 and 11 are flow diagrams illustrating the detailed procedural steps performed by an information processing system of FIG. 8;

FIG. 12 is a diagram illustrating operation of an information processing system of FIG. 8;

FIG. 13 is a diagram illustrating an example of an interface information table of the present embodiment;

FIG. 14 is a diagram illustrating an example of an interface information structure of the present embodiment;

FIG. 15 is a block diagram schematically illustrating an example of an operation performed when the technique of the present embodiment is applied to an information processing system of FIG. 1; and

FIG. 16 is a diagram illustrating a correlation among a polling thread to carry out packet transmission and reception, an NIC, and a CPU core in the example of FIG. 15.

### DESCRIPTION OF THE PREFERRED EMBODIMENTS

Hereinafter, an embodiment of a non-transitory computer-readable recording medium having stored therein a program, an information processing apparatus, an information processing system, and a method for processing information disclosed in this patent application will now be described with reference to the accompanying drawings. The following embodiments are exemplary, so there is no intention to exclude applications of various modifications and techniques not explicitly described in the following description to the embodiment. The accompanying drawings of the embodiments do not limit that the elements appearing therein are only provided but can include additional functions. The embodiments can be appropriately combined as long as no contradiction is incurred.

(1) Related Technique:

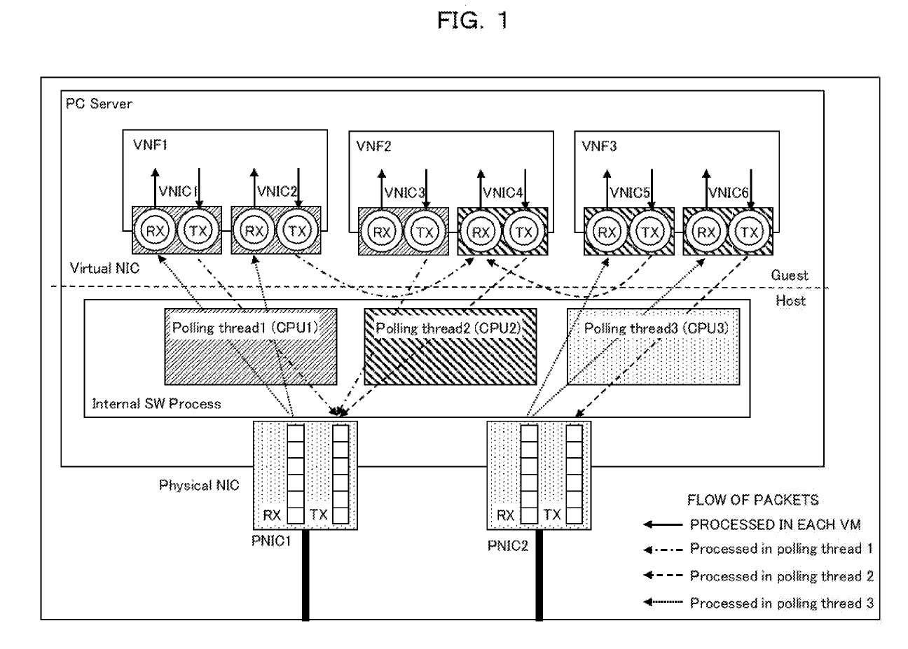

Here, description will now be made in relation to an example of the configuration and the operation of an NFV system adopting a polling scheme, as a technique (hereinafter called “related technique”) related to this application, with reference to FIG. 1. FIG. 1 is a block diagram schematically illustrating the related technique.

An NFV system illustrated in FIG. 1 is provided with a Personal Computer (PC) server having a multi-core processor. A multi-core processor includes multiple of CPU cores (processor cores). A single PC server (host) includes therein multiple (three in FIG. 1) VNFs each providing a network function installed therein. Each VNF is achieved, as a Guest on the Host, by a VM. Each VNF has multiple (two in FIG. 1) Virtual Network Interface Cards (VNICs). In addition, the PC server includes multiple (two in FIG. 1) Physical Network Interface Cards (PNICs) that transmit and receive packets to and from an external entity.

In FIG. 1, the three VNFs are referred to as a VNF 1, a VNF 2, and a VNF 3 by VNF numbers 1-3 that specify the respective VNFs. The two VNICs included in the VNF 1 are referred to as a VNIC 1 and a VNIC 2 by VNIC numbers 1 and 2 that specify the respective VNICs. Likewise, two VNICs included in the VNF 2 are referred to as a VNIC 3 and a VNIC 4 by VNIC numbers 3 and 4 that specify the respective VNICs; and two VNICs included in the VNF 3 are referred to as a VNIC 5 and a VNIC 6 by VNIC numbers 5 and 6 that specify the respective VNICs. The two PNICs included in the PC server are referred to as a PNIC 1 and a PNIC 2 by PNIC numbers 1 and 2 that specify the respective PNICs. The VNICs and PNICs are each provided with a reception port RX and a transmission port TX.

Packet transmission and reception processing in each VNF is processed by a CPU core allocated to the VNF. This means that packet transmission and reception processing on the host is processed in a polling thread, in other words, is processed by the CPU core of the host. In FIG. 1, three CPU cores are each allocated thereto a polling thread 1, a polling thread 2, and a polling thread 3, respectively. The three CPU cores are represented to be a CPU 1, a CPU 2, and a CPU 3 by attaching thereto core IDs 1-3 that specify the respective CPU cores.

In the VNF system of FIG. 1, allocation of a process of which port (NIC) to which polling thread is determined randomly. In the example of FIG. 1, the polling thread 1 (CPU 1) carries out packet process of transmission and reception processing of the VNIC 1, the VNIC 2, and the VNIC 3; the polling thread 2 (CPU 2) carries out packet transmission and reception processing of the VNIC 4, the VNIC 5, and the VNIC 6; and the polling thread 3 (CPU 3) carries out packet transmission and reception processing of the PNIC 1 and the PNIC 2. Hereinafter, a process of transmission and reception processing of packets is sometimes simply referred to as packet processing.

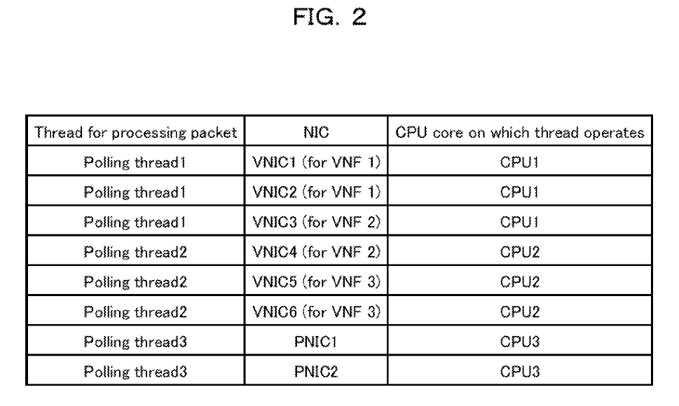

FIG. 2 illustrates a correlation among a polling thread that carries out packet transmission and reception processing, an NIC (virtual/physical interface) allocated to the polling thread, and a CPU core on which the polling thread operates of the example of FIG. 1. As illustrated in FIG. 2, a single polling thread operates using a single CPU core. In the configuration illustrated in FIG. 1, packet transmission and reception processing of the VNIC 1 to the VNIC 3 are carried out by the CPU 1; packet transmission and reception processing of the VNIC 4 to the VNIC 6 are carried out by the CPU 2; and packet transmission and reception processing of the PNIC 1 and the PNIC 2 are carried out by the CPU 3.

The state of allocating each VNF to a polling thread (CPU core) in a unit of a VNF is that the VNF 1 is allocated to the polling thread 1 (CPU core 1); and the VNF 3 is allocated to the polling thread 3 (CPU core 3). In contrast, the VNF 2 is allocated over to two threads of the polling threads 1 (CPU core 1) and the polling thread 2 (CPU core 2). Specifically, the VNIC 3 and the VNIC 4 belonging to the same VNF 2 are allocated to the respective different polling threads, i.e., the polling thread 1 (CPU core 1) and the polling thread 2 (CPU core 2), respectively.

Since the polling threads 1-3 are polling processes, the utility rate of the respective CPU cores by the polling threads are always 100% irrespective of packet processing being carried out or not being carried out.

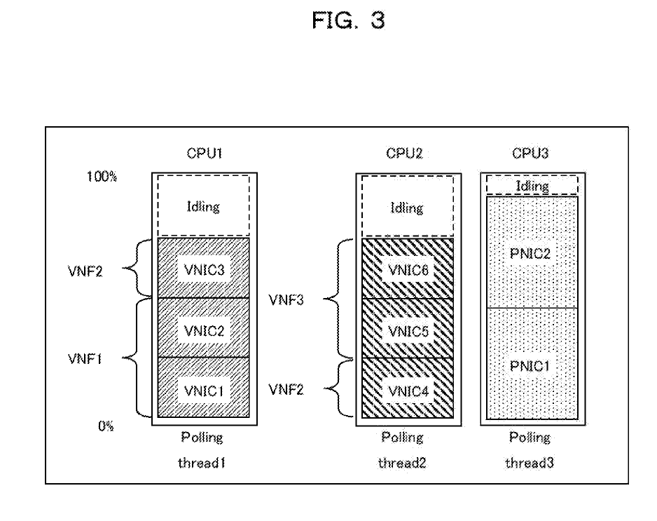

FIG. 3 illustrates packet processing of the VNF 1 to the VNF 3 being operating at their maximum capabilities to the capability of each of the polling thread 1 to the polling thread 3 (CPU 1 to CPU 3) under a state where the three VNFs of the VNF 1 to VNF 3 have the same capability of packet processing. In cases where the VNFs have the same capability of packet processing and the polling threads are of higher speed than the capabilities of packet processing of the VNFs, packet processing is completed within a time period during which a single CPU core can carry out the processing. Therefore, the VNFs can operate at their maximum capability of packet processing and do not contend each other for time for packet processing. Advantageously, this arises no capability interference among the VNFs.

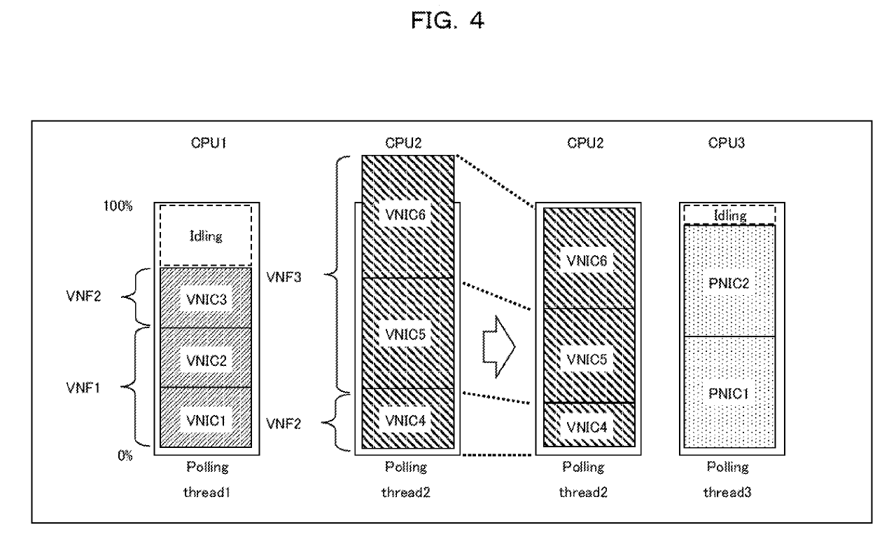

However, in a practical service, all the VNFs are scarcely the same in type and in capability of packet processing. In other words, the capability of packet processing is different with a VNF. For example, as illustrated in FIG. 4, if the VNF 3 has a high capability of packet processing, ratios of packet processing of the VNIC 5 and the VNIC 6 that the CPU 2 is processing increase. If this accompanies a situation where the CPU 2 is processing packet amount exceeding the packet amount that the CPU 2 can process, the CPU 2 is unable to process the exceeding packets. This causes packet loss and lowers the throughput of the VNF 3. At that time, time for packet processing of the VNIC 4 that is operating on the same CPU 2 also comes to be shorter, which also degrades the throughput of the packet processing of the VNF 2 that the VNIC 4 belongs to.

Furthermore, all the VNICs do not actually communicate using the same packet amount. If a packet processing amount of a particular VNIC increases, the throughput of packet processing of the VNFs except of the VNF that the particular VNIC belongs to are also affected and the throughputs of the other VNFs decreases.

Such lowering of the throughput of every VNF is an important issue to the communication carrier (provider) that provides the NFV service because the communication carrier (provider) goes into a situation where the capability of packet processing that the carrier has agreed with customers on is unable to be ensured. With this problem in view, ensuring the capability of packet processing in a unit of a VNF (virtual function) is demanded even in the environment wherein packets are processed in a polling scheme as the above.

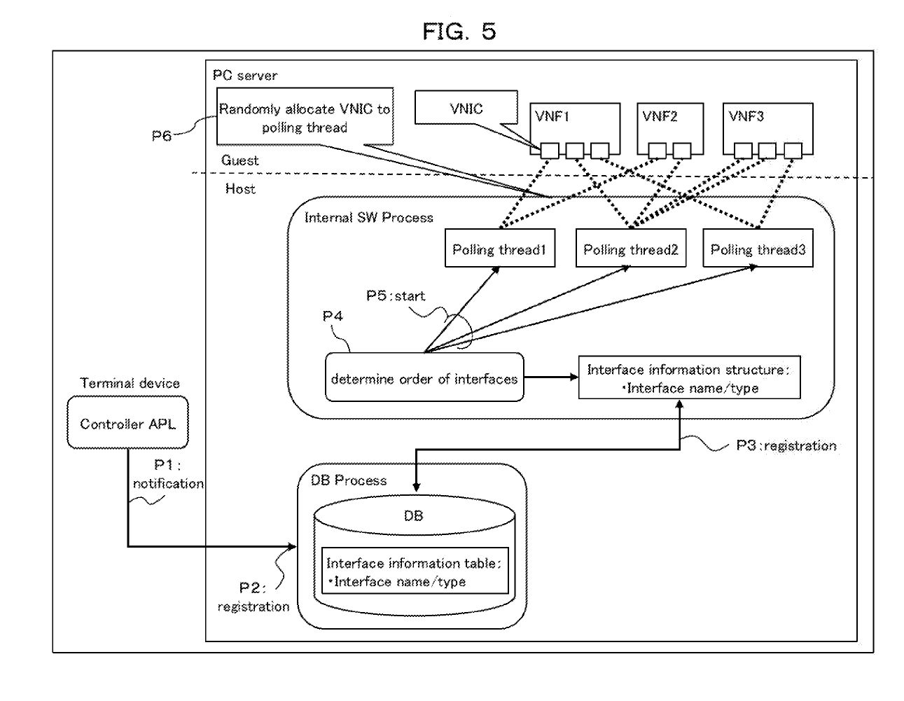

Hereinafter, description will now be made in relation to operation of an NFV system of the above related technique with reference to FIGS. 5-7. First, the operation of the NFV system (related technique) illustrated in FIG. 1 is schematically described with reference to the block diagram (processes P1-P6) of FIG. 5. Unlike FIG. 1, the NFV system of FIG. 5 does not include the PNICs and arranges three VNICs in each of the VNF 1 and the VNF 3 and two VNICs in the VNF 2.

To the PC server, a terminal device operated by the NFV service provider is connected by means of a Graphical User Interface (GUI) and a Command Line Interface (CLI). An example of the terminal device is a PC that may be connected to the PC server directly or via a network. The function of the terminal device may be included in the PC server. The terminal device carries out a controller application (Controller APL) to access the PC server in response to an instruction of the provider for controlling the PC server.

Process P1: In response to the instruction from the provider, the controller application specifies the interface name and the type of an NIC to be newly added and notifies the interface name and the type to the database (DB) of a PC server. Examples of the interface name are VNIC1 to VNIC6, PNIC1, and PNIC 2. An example of the type is information representing whether the NIC is a virtual interface (VNIC) or a physical interface (PNIC). Alternatively, the type maybe information representing another interface type except for virtual and physical types. Hereinafter, an “interface” regardless the type (virtual or physical) may be simply referred to as an “NIC”.

Process P2: Upon receipt of the notification containing the name and the type of the interface from the Controller APL, the DB registers the received interface name and type to an interface information table (DB process) in the DB.

Process P3: After the interface name and type are registered in the DB, the DB notifies an internal switch (SW) process of the completion of registering the interface name and type. Upon receipt of the notification from the DB, the internal SW process obtains the interface name and type from the DB and registers the interface name and type into an interface information structure in a memory region for the internal SW process.

Process P4: After the interface name and type are registered in the interface information structure, the internal SW process randomly determines order of the interfaces (VNICs) through calculating the Hash values.

Process P5: The internal SW process starts the polling threads (Polling thread 1 to Polling thread 3).

Process P6: The polling threads are allocated thereto the interfaces (VNICs) in the order determined in Process P4. This means that the interfaces (VNICs) are randomly allocated to the polling threads.

Thereafter, each polling thread operates its operation to process the packets of the allocated interface (VNIC).

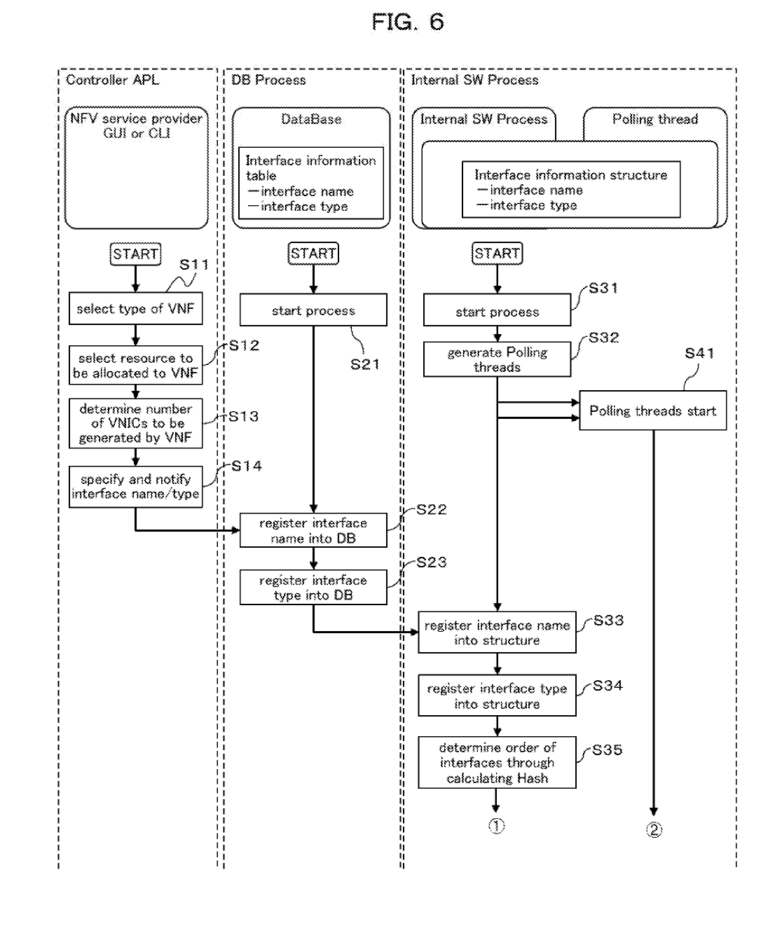

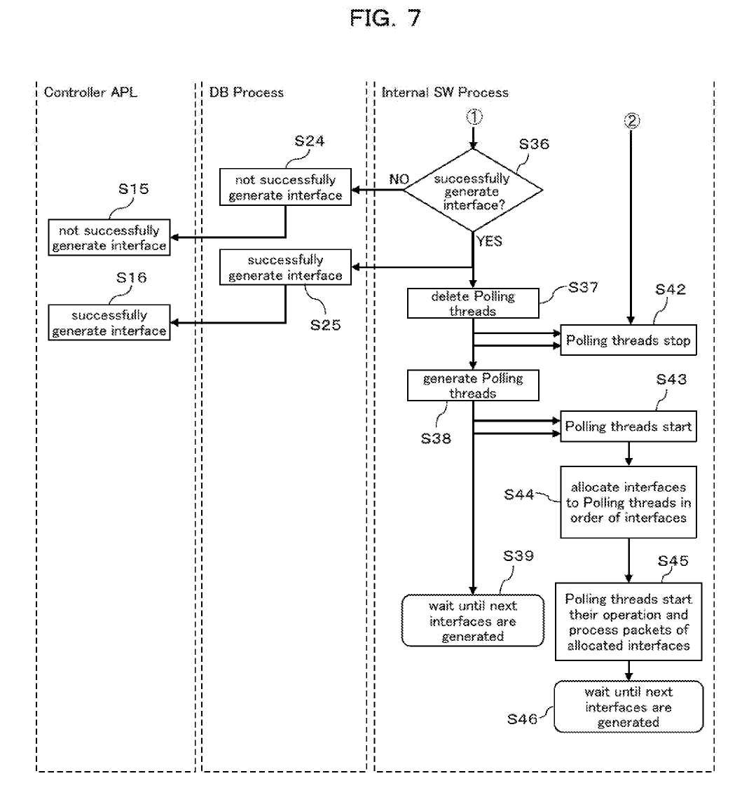

The operation of the NFV system (related technique) of FIG. 1 will now be further detailed with reference to the flow diagrams (Steps S11-S16; S21-S25; S31-S39; and S41-S46) of FIGS. 6 and 7.

The process of Steps S11-S16 is an operation performed by the terminal device (Controller APL) in response to the NFV service provider; the process of Steps S21-S25 is operation of the DB process; and the process of Step S31-S39 and Steps S41-46 is operation of the internal SW process wherein, in particular, the process of Steps S41-46 is an operation of each polling thread.

The NFV service provider (hereinafter, sometimes simply called “provider”) selects the type of the VNF to be newly added on a terminal device executing the Controller APL (Step S11 of FIG. 6). The provider selects the resource to be allocated to the VNF to be added, which is exemplified by a VM/VNF processing capability, on the terminal device (Step S12 of FIG. 6). In addition, the provider determines the number of VNICs to be generated for the VNF on the terminal device (Step S13 of FIG. 6). The provider specifies the interface name and the interface type of each NIC and notifies the DB process of the PC server of the interface name and the interface type (Step S14 of FIG. 6). The process of Step S14 corresponds to Process P1 of FIG. 5.

After being started (Step S21 of FIG. 6), the DB process of the PC server receives the notification from the Controller APL and then registers the received interface name to the interface information table of the DB (Step S22 of FIG. 6). Likewise, the DB process registers the received interface type to the interface information table of the DB (Step S23 of FIG. 6). The process of Steps S22 and S23 corresponds to Process P2 of FIG. 5.

After being started (Step S31 of FIG. 6), the internal SW process of the PC server automatically generates polling threads as many as the number of CPU cores (Step S32 of FIG. 6) and the generated polling threads are automatically started (Step S41 of FIG. 6). The number of CPU cores is given in advance by a predetermined parameter.

After that, the internal SW process of the PC server is notified, from the DB, of the completion of registering the interface name and type into the DB, and obtains the interface name and the interface type from the DB. Then the internal SW process of the PC server registers the interface name into the interface information structure (Step S33 of FIG. 6) and also registers the interface type into the interface information structure (Step S34 of FIG. 6). The process of steps S33 and S34 corresponds to Process P3 of FIG. 5.

After the completion of registering the name and type into the interface information structure, the internal SW process randomly determines order of the interfaces (VNICs) through calculating the Hash values (Step S35 of FIG. 6). The process of Step S35 corresponds to Process P4 of FIG. 5.

After determining the order, the internal SW process determines whether interfaces are successfully generated, which means that whether the process of Step S33-S35 is completed (Step S36 of FIG. 7). If interfaces are not successfully generated (NO route of Step S36), the internal SW process notifies the DB process of the failure (Step S24 of FIG. 7). Then the DB process notifies the provider (controller APL) of the failure (Step S15 of FIG. 7).

In contrast, if interfaces are successfully generated (YES route of Step S36), the internal SW process notifies the DB process of the success (Step S25 of FIG. 7). Then the DB process notifies the provider (controller APL) of the success (Step S16 of FIG. 7). Besides, the internal SW process deletes all the polling threads automatically generated when the process was started (Step S37 of FIG. 7) and consequently all the polling threads stop (Step S42 of FIG. 7).

After that, the internal SW process generates polling threads as many as the number of CPU cores (Step S38 of FIG. 7) and the generated polling threads are started (step S43 of FIG. 7). The process of Step S43 corresponds to Process P5 of FIG. 5. After generating the polling threads, the internal SW process waits until subsequent interfaces are generated (Step S39 of FIG. 7).

After the polling threads are started, the interfaces (VNICs) are allocated to the polling threads in the order determined in Step S35 (Step S44 of FIG. 7). In other words, the interfaces (VNICs) are randomly allocated to the polling threads. The process of Step S44 corresponds to Process P6 of FIG. 5.

Then the polling threads start their operation and process packets of the interfaces of the respective allocated interfaces (VNICs) (Step S45 of FIG. 7). After the completion of the packet process, each polling thread waits until subsequent interfaces are generated (Step S46).

(2) Overview of the Technique of the Present Invention:

This embodiment ensures the capability of packet processing for the VNF (virtual function) even in the environment that carries out packet processing in a polling scheme.

For the above, in the technique of the present invention, the packet processing of multiple VNFs (virtual function) each having one or more VNICs (virtual interfaces) is carried out by multiple CPU cores (processor cores, polling threads). In this event, multiple VNF are allocated to multiple CPU cores in a unit of VNF such that one or more VNICs included in the same VNF belong to a single CPU core among the multiple CPU cores. Furthermore, on the basis of weight values, multiple VNF are allocated to multiple CPU cores in a unit of VNF such that the sum of the processing capabilities of the VNFs to be allocated does not exceed the maximum capability of packet processing of each CPU cores. Here, a weight value is previously obtained for each VNF and represents, for example, a ratio of the capability of packet processing of the VNF to the maximum capability of the packet processing of a CPU core (polling thread) (see the following Expression (1)).

Specifically, the technique of the present invention measures the maximum capability of packet processing of a polling thread in an individual CPU core and the maximum capability of the packet processing in each VNF, using a CPU (multi-core processor) that practically provides NFV service in advance. A value of the maximum capability of the packet processing of each VNF to the maximum capability of packet processing of a CPU core is determined to be the weight value of each VNF.

In the technique of the present application, the VNIC or PNIC is mapped (allocated) to a polling thread in a unit of a VNF, instead of a unit of an NIC. This means that the technique of the present application is provided with a first function that allocates multiple VNICs belong to a common VNF to the same CPU core (polling thread).

In addition, the technique of the present application maps (allocates) VNICs to each polling thread with reference to the weight value such that the sum of the processing capabilities of the VNICs to be allocated to the same polling thread does not exceed the maximum processing capability of the polling thread (within the maximum capability of packet processing). In this event, the VNFs are allocated, in the descending order of an amount of processing (i.e., a weight value), to the CPU cores such that the sum of the processing capabilities of the VNFs to be allocated does not exceed the processing capability of each CPU core (i.e., the operation environment of each polling thread). This means that the technique of the present application is provided with a second function that appropriately selects a polling thread (CPU of the host) in accordance with the capability of each VNF such that the sum of the VNFs allocated to each polling thread does not exceed the processing capability of the polling thread.

The above first function makes it possible to reserve the capability of packet processing for each VNF. In particular, even if the packet processing is unevenly loaded on a certain VNIC, capability of VNFs is avoided from interfering with one another.

The above second function makes it possible to reserve the maximum capability of packet processing in a unit of a VNF and also to prevent a certain VNF from affecting the capabilities of packet processing of the remaining VNFs.

As the above, the technique of the present application can configure an NFV system (information processing system) in which VNFs different in capability of packet processing can exert their maximum capability of packet processing. Consequently, there can be provided an NVF service ensuring the maximum capability, not in the best-effort manner.

In addition to the above, the technique of the present application can configure an NFV system in which, even if VNFs different in capability of packet processing operate at their maximum capability of packet processing, they do not affect the capabilities of packet processing of the remaining VNFs. Consequently, multitenancy can be achieved in the NFV environment, and resource independency among tenant users can be enhanced.

Furthermore, the technique of the present application establishes a scheme of ensuring the capability of packet processing of a VNF in the environment wherein the packet processing is carried out in a polling scheme as the above. Even if the packet processing is unevenly loaded on a certain NIC, the technique of the present application does not affect the capability of packet processing by the remaining NICs and VNFs.

(3) Hardware Configuration and Functional Configuration of a Present Embodiment:

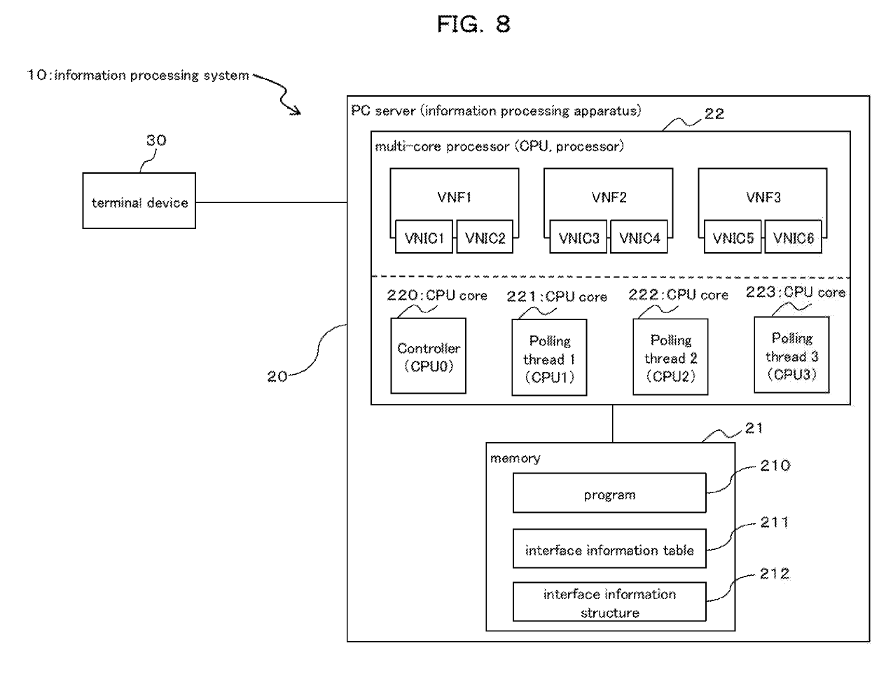

Description will now be made in relation to the hardware configuration and the functional configuration of an information processing system (NFV system) 10 and an information processing apparatus (PC server 20) of a present embodiment with reference to FIG. 8. FIG. 8 is a diagram illustrating the hardware configuration and the functional configuration of the system and the apparatus. As illustrated in FIG. 8, the information processing system 10 of the present embodiment includes the PC server 20 and a terminal device 30.

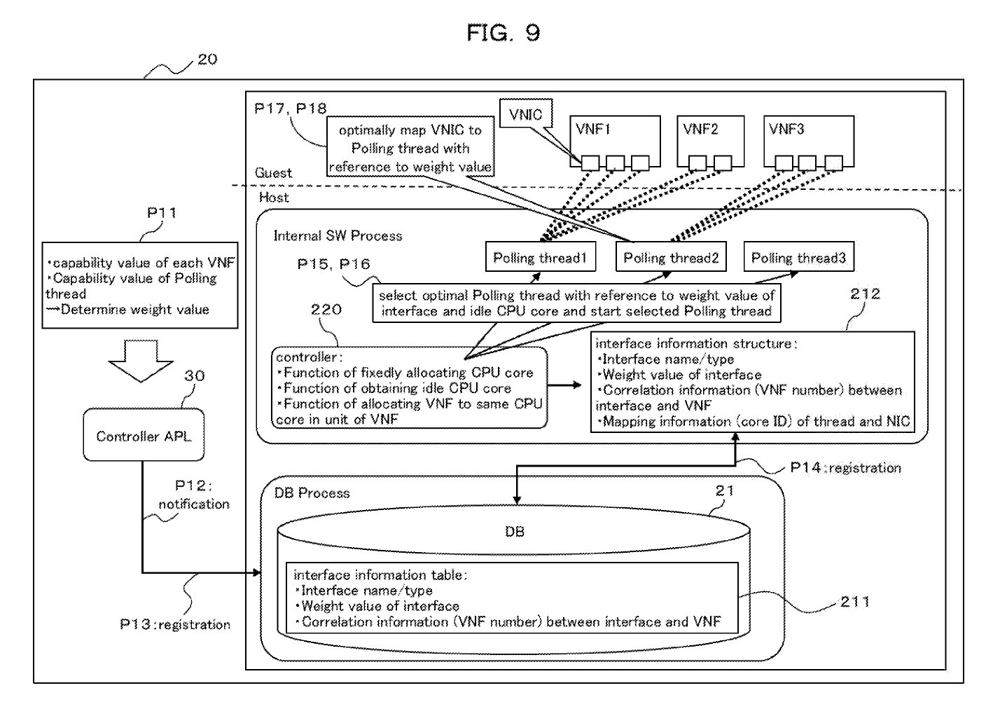

The terminal device 30 is exemplified by a PC and is operated by a NFV service provider using a GUI or a CLI to access the PC server 20. The terminal device 30 may be directly connected to the PC server 20 or may be connected to the PC server 20 via a network (not illustrated). The function of the terminal device 30 may be included in the PC server 20. In response to an instruction from the above provider, the terminal device 30 accesses the PC server 20 and executes a controller application (CONTROLLER APL; see FIG. 9) to control the PC server 20.

In addition to a processor, such as CPU, and a memory that stores therein various pieces of data, the terminal device 30 may include an input device, a display, and various interfaces. With this configuration, the processor, the memory, the input device, the display, and the interfaces are communicably connected to one another via a bus, for example.

An example of the input device is a keyboard and a mouse, and is operated by the provider issue various instructions to the terminal device 30 and the PC server 20. The mouse may be replaced with, for example, a touch panel, a tablet computer, a touch pad, or a track ball. An example of the display is a Cathode Ray Tube (CRT) monitor and a Liquid Crystal Display, and displays information related to various processes. The terminal display 30 may further include an output device that prints out the information related to the various processes in addition to the display. The various interfaces may include an interface for a cable or a network that connects between the terminal device 30 and the PC server 20 for data communication.

The PC server (information processing apparatus) 20 includes a memory 21 and a processor 22, and may further include an input device, a display, and various interfaces likewise the terminal device 30. The memory 21, the processor 22, the input device, the display, and the various interface are communicably connected with one another via, for example, a bus.

The memory 21 stores various pieces of data for various processes to be made by the processor 22. It is sufficiently that the memory 21 includes at least one of a Read Only Memory (ROM), a Random Access Memory (RAM), a Storage Class Memory (SCM), a Solid State Drive (SSD), and a Hard Disk Drive (HDD).

The above various pieces of data include an interface information table 211 and an interface information structure 212 that are to be detailed below, and a program 210. The memory 21 stores a DataBase (DB) that registers and stores the interface information table 211 and a memory region that registers and stores therein the interface information structure 212. The interface information table 211 will be detailed below with reference to FIGS. 9, 10, and 13; and the interface information structure 212 will be detailed below with reference to FIGS. 9, 10, and 14.

The program 210 may include an Operating System (OS) program and an application program that are to be executed by the processor 22. The application program may include: a program that causes the CPU core 220 of the processor 22 to function as a controller that is to be detailed below; a program that causes the terminal device 30 or the CPU core 220 to execute a process of calculating a weight value with the following Expression (1); and a controller application (CONTROLLER APL; see FIG. 9) to be executed by the terminal device 30.

The application programs included in the program 210 may be stored in a non-transitory portable recording medium such as an optical disk, a memory device, and a memory card. The program stored in such a portable recording medium comes to be executable after being installed into the memory 21 under the control of the processor 22, for example. Alternatively, the processor 22 may directly read the program from such a portable recording medium and execute the read program.

An optical disk is a non-transitory recording medium in which data is readably recorded by utilizing light reflection. Examples of an optical disk are a Blu-ray, a Digital Versatile Disc (DVD), a DVD-RAM, a Compact Disc Read Only Memory (CD-ROM), and a CD-R (Recordable)/RW (ReWritable). The memory device is a non-transitory recording medium having a function of communicating with a device connection interface (not illustrated), and is exemplified by a Universal Serial Bus (USB) memory. The memory card is a card-type non-transitory recording medium which is connected to the processor 22 via a memory reader/writer (not illustrated) to become a target of data writing/reading.

The processor 22 is a CPU (multi-core processor) having multiple (four in FIG. 8) CPU cores (processor cores) 220-223. A single PC server (host) 20 is provided with multiple (three in FIG. 8) VNFs (virtual functions) that provide network functions. Each VNF is achieved as a guest of the host by a VM. Each VNF includes multiple (two in FIG. 8) VNICs (virtual interfaces). The processor 22 carries out packet processing of the multiple VNFs (packet transmission and reception processing) in multiple CPU cores (polling threads) 221-223. The PC server 20 may include a physical interface (PNIC) that transmits and receives packets to and from an external device that is not depicted in FIG. 8.

In FIG. 8, the three VNFs are referred to as a VNF 1, a VNF 2, a VNF 3 by attaching thereto VNF numbers (first identification information) 1-3 that identify the respective VNFs. The two VNICs included in the VNF 1 are referred to as a VNIC 1 and a VNIC 2 by attaching thereto VNIC numbers 1 and 2 that identify the respective VNICs; the two VNICs included in the VNF 2 are referred to as a VNIC 3 and a VNIC 4 by attaching thereto VNIC numbers 3 and 4 that identify the respective VNICs; and the two VNICs included in the VNF 3 are referred to as a VNIC 5 and a VNIC 6 by attaching thereto VNIC numbers 5 and 6 that identify the respective VNICs.

Packet transmission and reception processing in the VNF 1 to the VNF 3 is processed by the CPU cores 221-223 allocated to the respective VNFs. This means that the packet transmission and reception processing on the host is processed in polling threads, in other words, is processed by the CPU cores 221-223 of the host. In FIG. 8, the three CPU cores 221-223 are each allocated thereto a polling thread 1, a polling thread 2, and a polling thread 3, respectively. The three CPU cores 221-223 are referred to as a CPU 1, a CPU 2, and a CPU 3 by attaching thereto core IDs 1-3 that specify the respective CPU cores.

The CPU core 220 in the processor 22 of this embodiment executes the application program stored in the program 210 to function as a controller. The controller 220 controls the processor 22 (CPU cores 221-223) in response to an instruction from the terminal device 30.

In this embodiment, before the controller 220 starts the control, the following maximum capability of packet processing is measured and stored in, for example, the terminal device 30 in advance. Specifically, the maximum capability of packet processing of a polling thread (i.e., CPU core) per CPU core and the maximum capability of packet processing per VNF are measured with the CPU (multi-core processor) 22 that practically provides an NFV service, and are stored in advance. Throughout this description, the maximum capability of packet processing represents the maximum number of packets that a CPU or a VNF can process in a unit time and is represented in a unit of, for example, pps (packets per second).

Then, the terminal device 30 determines a weight value of each VNF by the Controller APL (see FIG. 9) using the following Expression (1) and the determined weight values are stored. The process of determining and storing a weight value of each VNF may be carried out in the terminal device 30 or in the processor 22 of the PC server 20.

(weight value of each VNF)=(maximum capability of packet processing of VNF)/(maximum capability of packet processing of polling thread)×100100 (Expression (1))

Here, the weight value determined with the Expression (1) represents a ratio of the maximum capability of packet processing of each VNF to the maximum capability of packet processing of each CPU core, which means the capability of packet processing on a polling thread in each CPU core. When the maximum capability of packet processing of a VNF is equal to the maximum capability of packet processing of a polling thread per CPU core, the weight value of the VNF is calculated to be 100.

The controller 220 of the present embodiment exerts the following function.

In first instance, the controller 220 allocates the VNFs to the CPU cores 221-223 in a unit of a VNF such that one or more VNICs included in the same VNF belonging to a single CPU core among the multiple CPU cores 221-223. In other words, the controller 220 allocates VNICs to polling threads in a unit of a VNF, instead of a unit of an NIC. Consequently, the controller 220 exerts a first function for allocating the multiple VNICs belonging to the same VNF to the same CPU core (polling thread).

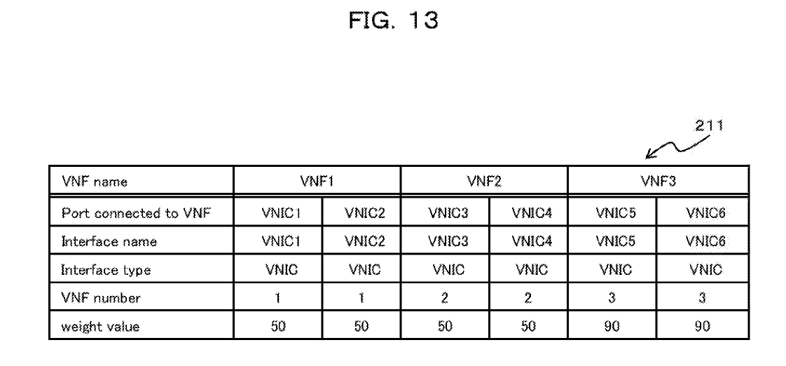

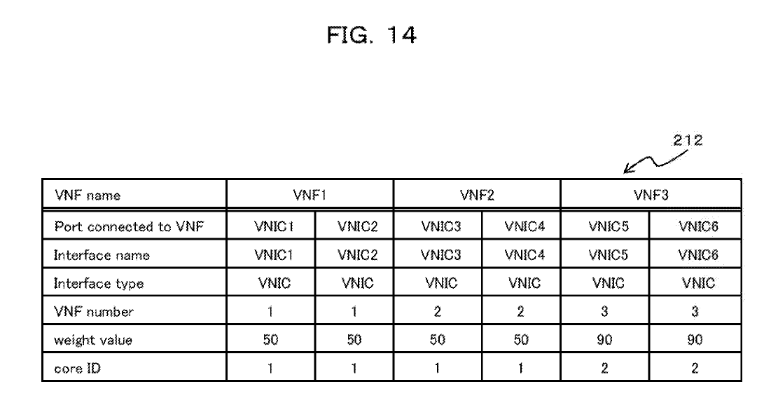

For this purpose, in generating the VNICs, this embodiment attaches VNF numbers (first identification information) representing each VNIC being generated is to be used in which VNF. Consequently, a VNIC (interface name and type) being generated and a VNF number are stored and registered in the interface information table 211 (see FIG. 13) and the interface information structure 212 (see FIG. 14) in association with each other. When a polling thread is selected which is to carry out packet process of a VNIC, the controller 220 allocates the VNICs belonging to the same VNF to the same polling thread with reference to the interface information structure 212.

In this event, the controller 220 allocates VNICs to each polling thread, with reference to the weight value determined in the above manner, such that the sum of the processing capabilities of VNICs to be allocated to the same polling thread does not exceed the maximum capability of packet processing of the polling thread. Specifically, the controller 220 obtains a current status of allocation to each polling thread and determines n idle (available) polling thread, which will be detailed below. Then, the VNFs are allocated to CPU cores in descending order of a processing amount of each VNF (larger weight values) within the capability of processing of each CPU core (working environment of each polling thread). Consequently, the controller 220 exerts a second function of appropriately selecting a polling thread within the capability of processing of the polling thread, considering the capability of each VNF.

In exerting the above second function, the controller 220 also exerts the following functions.

In allocating a VNF (hereinafter sometimes referred to as a target VNF) including a VNIC to one of the CPU cores 221-223, the controller 220 determines whether a VNF number (first identification information) of the target VNF is already registered in the interface information structure 212. If the VNF number of the target VNF is already registered, the controller 220 obtains the core ID (second identification information) allocated thereto the target VNF and stores the obtained core ID into the interface information structure 212 (see FIG. 14). Then the controller 220 allocates the new VNIC of the target VNF to the obtained CPU core corresponding to the obtained core ID.

If the VNF number of the target VNF is not registered in the interface information structure 212, the controller 220 calculates the sum of the weight values of the VNFs allocated to each of the CPU cores 221-223 and determines a CPU core that affords to further contain the target VNF on the basis of the sum of the weight values calculated for each CPU core and the weigh value of the target VNF.

The controller 220 sorts the multiple CPU cores in descending order of the sum value. The controller 220 compares, in the order obtained by the sorting, a value representing an idle ratio of each of the sorted CPU cores 221-223 and the weight value of the target VNF to determine a CPU core that affords to further contain the target VNF.

If a CPU core that affords to allocate thereto the target VNF is not determined, the controller 220 sorts the multiple VNFs already allocated to the CPU cores 221-223 and the target VNF in descending order of the weight values of the VNFs. The controller 220 allocates again the VNFs and the target VNF having undergone the sorting to the CPU cores 221-223 in a unit of a VNF in the order obtained by the sorting. The weight value of each VNF represents the ratio of the maximum capability of packet processing of each VNF to the maximum capability of packet processing of each CPU core.

(4) Operation of the Present Embodiment:

Next, description will now be made in relation to an operation of the information processing system (NFV system) 10 and the PC server 20 of the present embodiment described above with reference to FIGS. 9-16. First of all, description will now be schematically made in relation to an operation of the NFV system 10 and the PC server 20 illustrated in FIG. 8 with reference to a block diagram (Process P11-P18) in FIG. 9. Unlike FIG. 8, in the NFV system 10 illustrated in FIG. 9, the VNF 1 and the VNF 3 each include three VNICs and the VNF 2 includes two VNICs.

Before the controller APL carries out processes P11-P18, the maximum capability (capability value) of processing packet in a polling thread per CPU core and the maximum capability (capability value) of processing packet per VNF are measured and stored.

Process P11: In the terminal device 30, the Controller APL determines the weight value of each VNF from the above Expression (1) on the basis of the performance value of each VNF and the performance value of each polling thread that are measured and stored in advance.

Process P12: In response to an instruction from the provider, the Controller APL notifies the interface name and type of an NIC to be newly added to the DB (memory 21) of the PC server 20, specifying the VNF number that identifies the VNF to which the NIC belongs and the weight value of the VNF. The interface name is, for example, one of VNIC 1-VNIC 6, PNIC 1, and PNIC 2. The type is information indicating that the NIC is a VNIC or a PNIC, for example. Alternatively, the type may contain information representing a type of interface except for virtual and physical interfaces.

P13: Upon receipt of the interface name and type, the VNF number, and the weight value from the controller APL, the DB registers the received interface name and type, VNF number, and weight value into the interface information table 211 for each interface (NIC) (DB process) as illustrated in FIG. 13. The VNF number corresponds to correlation information between the interface (NIC) and the VNF.

Process 14: After the interface name and type, the VNF number, and the weight value are registered in the DB, the DB notifies the internal SW process of the completion of the registration of the new information. Upon receipt of the notification from the DB, the internal SW process obtains the interface name and type, the VNF number, and the weight value from the DB, and registers the received information for each interface (NIC) into the interface information structure 212 in the memory region (memory 21) for the internal SW process as illustrated in FIG. 14. At this time point, the CPU core (polling thread) that is to be in charge of packet processing of the interface (NIC) is not determined yet, the field of the core ID of the CPU core associated with the interface remains blank. The core ID corresponds to mapping information of a polling thread (CPU core) and an interface (NIC).

Process 15: In the related technique described with reference to FIGS. 1-7, the interfaces (VNIC) are randomly allocated to the polling thread. In contrast to the above, in the PC server 20 of the present embodiment, the controller (CPU core) 220 determines a polling thread that allocates thereto the VNIC using the function of fixedly allocating of a CPU core, a function of obtaining an idle CPU core, and a function of allocating a VNF in a unit of a VNF to the same CPU core. Specifically, the controller 220 selects an appropriate polling thread from the weighting value of the interface (VNIC) and a CPU core (idle CPU core) having an available capability of processing, and allocates the interface (VNIC) to the selected polling thread. Then the core ID identifying the selected polling thread (CPU core) is registered into the interface information structure 212. In detail, the Process P15 is accomplished by performing the following sub-processes P15-1 through P15-5.

Sub-process P15-1: In allocating a VNF (target VNF) including a VNIC to one of the CPU cores 221-223, the controller 220 determines whether a VNF number of the target VNF is already registered in the interface information structure 212. If the VNF number of the target VNF is already registered, the controller 220 obtains the core ID of the CPU core allocated thereto the target VNF and moves to sub-process P15-5.

Sub-process P15-2: If the VNF number of the target VNF is not registered in the interface information structure 212, the controller 220 calculates the sum of the weight values of the VNFs allocated to each of the CPU cores 221-223 (multiple polling threads).

Sub-process P15-3: The controller 220 sorts the multiple CPU cores 221-223 (polling thread 1 to polling thread 3) in descending order of the sum calculated in sub-process P15-2. Then the controller 220 compares, in the order obtained by the sorting, a value representing an idle ratio of each of the sorted CPU cores 221-223 and the weight value of the target VNF to determine a CPU core (polling thread) that afford to be allocated (containable) to the target VNF. If a containable polling thread is successfully determined, the controller 220 moves to sub-process P15-5.

Sub-process P15-4: If a containable polling thread is not successfully determined, the controller 220 sorts the multiple VNFs already allocated to the CPU cores 221-223 and the target VNF in descending order of the weight value of each VNF. The controller 220 allocates again the VNFs and the target VNF having undergone the sorting to the CPU cores 221-223 in a unit of VNF in the order obtained by the sorting, so that the core IDs of the CPU cores that are to carry out packet processing of the respective interfaces (NICs) are set again.

Sub-process P15-5: The controller 220 registers the core ID obtained in sub-process P15-1, the core ID determined in sub-process P15-3, or the core IDs set again in sub-process P15-4 into the interface information structure 212.

Process P16: The internal SW process (controller 220) starts the polling threads (polling thread 1 to polling thread 3).

Process P17: The internal SW process (controller 220) determines the core IDs of the respective polling threads in accordance with order of starting the polling threads.

Process P18: The internal SW process (controller 220) allocates an interface (VNIC) associated with the core ID matching a core ID of a certain polling thread to the polling thread (CPU core) having the core ID with reference to the interface information structure 212.

After that, the polling threads (CPU cores 221-223) start their operation to process packets of the respective allocated interface (VNICs).

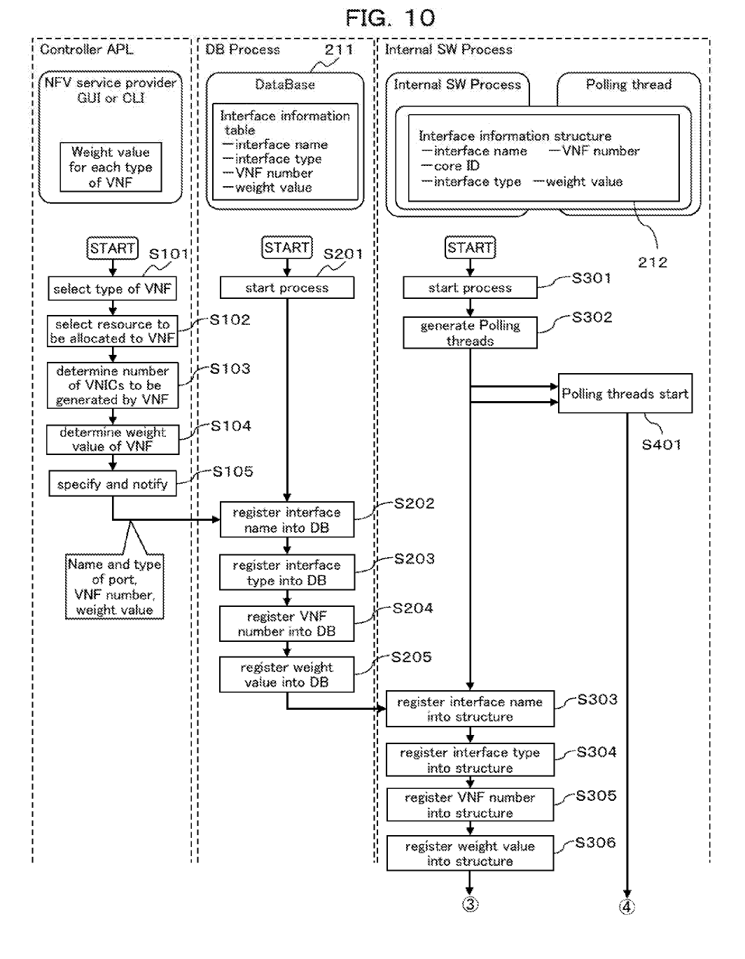

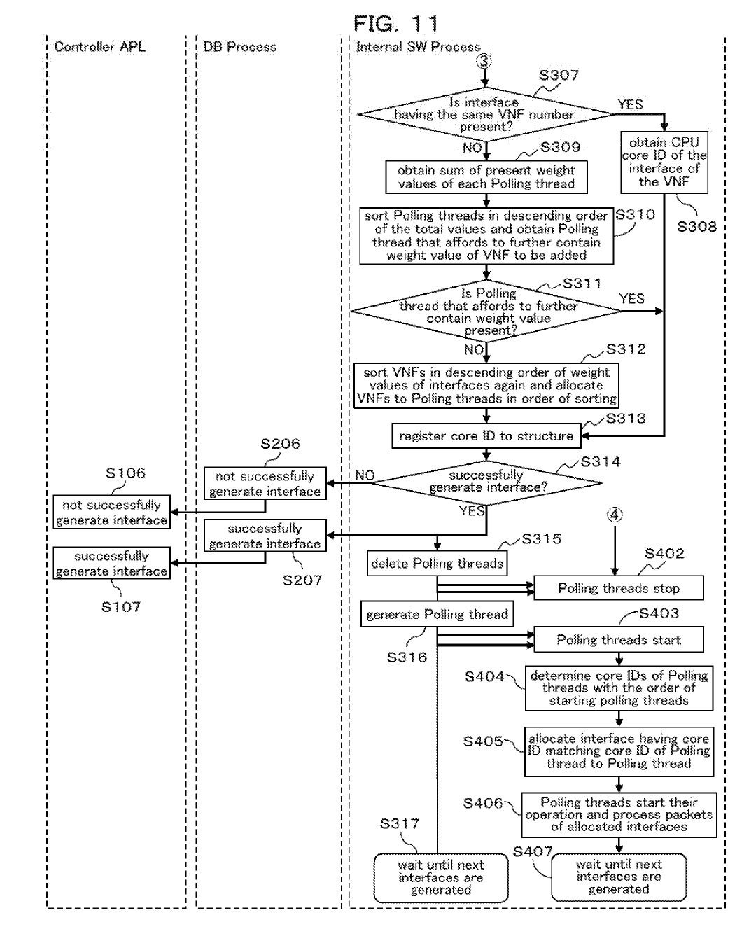

The operation of the NFV system 10 illustrated in FIGS. 8 and 9 will now be further detailed along the flow diagrams (Steps S101-S107; S201-S207; S301-S317; S401-S407) of FIGS. 10 and 11.

The process of Steps S101-S107 is operation performed by the terminal device 30 (Controller APL) in response to the NFV service provider; the process of Steps S201-S207 is an operation of the DB process; and the process of Step S301-S317 and Steps S401-S407 is an operation of the internal SW process (controller 220) wherein, in particular, the process of Step S401-S407 is operation of each polling thread (CPU cores 221-223).

The NFV service provider selects the type of the VNF to be added on a terminal device 30 executing the Controller APL (Step S101 of FIG. 10). The provider selects the resource to be allocated to the VNF to be added, which is exemplified by a VM/VNF processing capability, on the terminal device 30 (Step S102 of FIG. 10). In addition, the provider determines the number of VNICs to be generated by the VNF on the terminal device (Step S103 of FIG. 10).

In the terminal device 30, the weight value of each VNF is determined from the above Expression (1) on the basis of the capability value of each VNF and the capability value of each polling thread that are measured and stored in advance (Step S104 of FIG. 10). The process of Step S104 corresponds to Process P11 of FIG. 9.

Using the terminal device 30, the provider specifies the interface name and the interface type of each NIC, the VNF number that identifies a VNF to which the NIC belongs, and the weight value of the VNF, and notifies the DB (memory 21) of the PC server 20 of the specified information (Step S105 of FIG. 10). The process of Step S105 corresponds to process P12 of FIG. 9.

After being started (Step S201 of FIG. 10), the DB process of the PC server 20 receives notification from the Controller APL and registers the received interface name into the interface information table 211 in the DB (see Step S202 of FIG. 10, FIG. 13). Likewise, the DB process registers the received interface type into the interface information table 211 in the DB (see Step S203 of FIG. 10, FIG. 13). Furthermore, the DB process registers the received VNF number into the interface information table 211 in the DB (see Step S204 of FIG. 10, FIG. 13), and registers the received weight value into the interface information table 211 in the DB (see Step S205 of FIG. 10, FIG. 13). The process of Steps S202-S205 correspond to Process P13 of FIG. 9.

On the other hand, after being started (Step S301 of FIG. 10), the internal SW process in the PC server 20 automatically generates polling threads as many as the number of CPU cores (Step S302 of FIG. 10). The generated polling threads are automatically generated (Step S401 of FIG. 10). The number of CPU cores is given from a predetermined parameter in advance.

After that, the internal SW process in the PC server (controller 220) is notified of the completion of registration of the interface name/type, the VNF number, and the weight value into the DB by the DB, and obtains the interface name/type, the VNF number, and the weight value from the DB. Then the SW process of the PC server 20 registers the interface name into the interface information structure 212 (Step S303 of FIG. 10; see FIG. 14), and registers the interface type into the interface information structure 212 (Step S304 of FIG. 10; see FIG. 14). Likewise, the internal SW process registers the VNF number into the interface information structure 212 (Step S305 of FIG. 10; see FIG. 14), and registers the weight value into the interface information structure 212 (Step S306 of FIG. 10; see FIG. 14). The process of Steps S303-S306 correspond to Process P14 of FIG. 9.

Upon completion of registration into the interface information structure 212, the internal SW process (controller 220) refers to the interface information structure 212 and determines whether the VNF number of the target VNF is present (is registered) in the interface information structure 212 (Step S307 of FIG. 11). If the VNF number is present (YES route in Step S307), the controller 220 obtains a core ID of a single CPU core allocated thereto the target VNF, that is, a CPU core ID associated with an interface (VNIC) of the target VNF (Step S308 of FIG. 11) and then moves to the process of Step S313. The process of Steps S307 and S308 correspond to the above process 15-1.

On the other hand, if the VNF number is not registered in the interface information structure 212, the controller 220 calculates the sum of the weight values of the current VNF values allocated to each of the multiple polling threads (Step S309 of FIG. 11). The process of Step S309 corresponds to the above Process P15-2.

After that, the controller 220 sorts the polling threads 1 to the poling thread 3 in the descending order of a sum calculated in Step S309. Then the controller 220 compares a value representing an idle ratio of the CPU cores 221-223 with the weight value of the target VNF (VNF to be added) in the order obtained by the sorting, and thereby determines and obtains a polling threads that can further contain the target VNF (Step S310 of FIG. 11). If a polling thread that can further contain the target VNF is successfully determined, which means that a polling thread that can further contain the target VNF exists (YES route in Step S311 of FIG. 11), the controller 220 moves to Step S313. The process of Steps S310 and S311 correspond to the above Process P15-3.

If a polling thread that can further contain the target VNF is not successfully determined, which means that a polling thread that can further contain the target VNF is absent (NO route in Step S311 of FIG. 11), the controller 220 sorts the multiple VNFs already allocated to the multiple CPU cores 221-223 and the target VNF in descending order of a weight value. Then the controller 220 allocates the sorted multiple VNFs and the target VNF to the multiple polling threads in a unit of a VNF in the order obtained by the sorting, so that the core IDs of the CPU cores that are in charge of the packet processing of all the interfaces (NIC) are set again (Step S312 of FIG. 11). The process of Step S312 corresponds to Process P15-4.

Then the controller 220 registers the core IDs obtained in Step S308 or determined in Step S310 or set again in Step S312 into the interface information structure 212 (Step S313 in FIG. 11).

After that, the internal SW process determines whether the interfaces are successfully generated, which means whether the process of Steps S303-S304 is completed (Step S314 of FIG. 11). If the interfaces are not successfully generated (NO route of Step S314), the internal SW process notifies the DB process of the failure (Step S206 of FIG. 11). Furthermore, the DB process notifies the provider (control APL of the terminal device 30) of the failure (Step S106 of FIG. 11).

If the interfaces are successfully generated (YES route of Step S314), the internal SW process notifies the DB process of the success (Step S207 of FIG. 11). Furthermore, the DB process notifies the provider (control APL of the terminal device 30) of the failure (Step S107 of FIG. 11). In addition, the internal SW process deletes all the polling threads automatically generated when the process is started (Step S315 of FIG. 11) and consequently, all the polling thread stop (Step S402 of FIG. 11).

After that, the internal SW process generates polling threads as many as the number of CPU cores (Step S316 of FIG. 11) and the generated polling threads start (Step S403 of FIG. 11). The process of Step S403 corresponds to Process P16 of FIG. 9. After generating the polling threads, the internal SW process waits until the next interfaces are generated (Step S317 of FIG. 11).

After the polling threads start, the internal SW process (controller 220) determines the core ID for a polling thread, depending on the order of starting polling threads (Step S404 of FIG. 11). The process of Step S404 corresponds to Process P17 of FIG. 9.

After that, the internal SW process (controller 220) refers to the interface information structure 212 and allocates an interface (VNIC) the core ID of which is the same as the core ID of a polling thread to the polling thread (Step S405 of FIG. 11). The process of Step S405 corresponds to the above Process P18 of FIG. 9.

Then the respective polling threads (CPU cores 221-223) start their operations and process packets of the respective interfaces (VNICs) allocated thereto (Step S406 of FIG. 11). After completion of the packet processing, the respective polling threads wait until a subsequent interface is generated (Step S407 of FIG. 11).

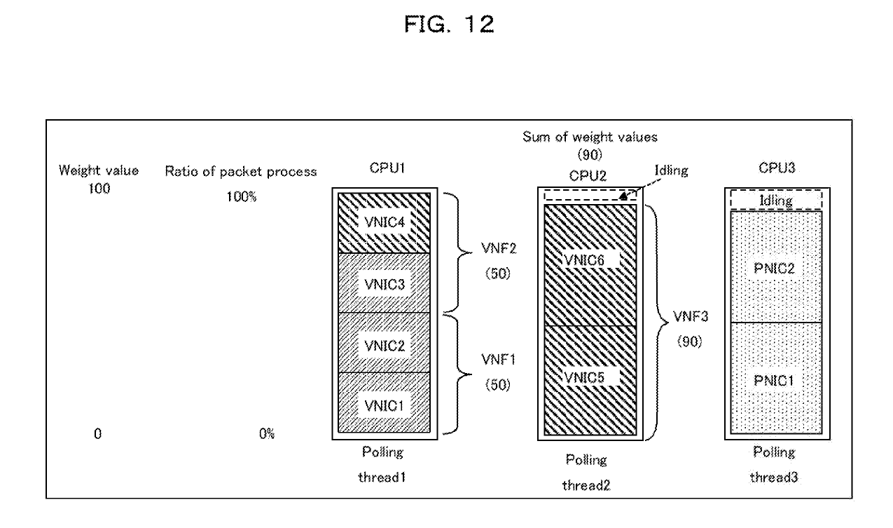

Next, description will now be made in relation to an example of the operation of the related technique illustrated in FIG. 4 applying the information processing system 10 of the present embodiment with reference to FIG. 12. In FIG. 12, the information processing system 10 of the present embodiment optimally maps the NICs (interfaces) over the polling threads.

In the examples illustrated in FIGS. 4 and 12, the VNF 1 includes the two interfaces (ports) VNIC 1 and VNIC 2; the VNF 2 includes the two interfaces VNIC 3 and VNIC 4; and the VNF 3 includes the two interfaces VNIC 5 and VNIC 6. The VNF 1, the VNF 2, and the VNF 3 are assumed to have weight values of 50, 50, and 90, respectively.

Under this assumption, the example of the operation of the related technique of FIG. 4 randomly maps VNICs or PNICs over polling threads in a unit of an NIC. Consequently, as illustrated in FIG. 4, the VNF 2 is allocated over two polling threads of the polling thread 1 and the polling thread 2. Specifically, the VNIC 3 and the VNIC 4, both of which belong to the VNF 2, are allocated to the different polling threads of the polling thread 1 and the polling thread 2, respectively. In the example of FIG. 4, the high capability of packet processing that the VNF 3 has increases the ratio of packet processing of the VNIC 5 and the VNIC 6 that the polling thread 2 is processing, resulting in generating of packet loss in the polling thread 2 to degrade the capability of the VNF 3 as described above.

In contrast to the above, the present embodiment maps VNICs and PNICs to polling threads not in a unit of an NIC but in a unit of a VNF. This means that multiple VNICs belonging to the same VNF are allocated to the same polling thread (first function). In addition, the present embodiment appropriately selects a polling thread to be allocated thereto an interface, depending on the capability of a VNF such that the sum of the capabilities of one or more allocated VNFs does not exceed the capability (i.e., weight value of 100) of processing that the polling thread has (second function).

Accordingly, as illustrated in FIG. 12, the present embodiment maps the VNF 1 (VNIC 1 and VNIC 2) having a weight value 50 and the VNF 2 (VNIC 3 and VNIC 4) having a weight value 50 over the polling thread 1. The sum of the weight values of the VNF 1 and the VNF 2 are 100, which does not exceed the weight value 100 corresponding to the maximum capability of the packet processing that the polling thread 1 has. As illustrated in FIG. 12, over the polling thread 2, the VNF 3 having a weight value of 90 not exceeding the maximum capability (i.e., weight value of 100) of processing that the polling thread 2 has is mapped.

As described above, since the present embodiment can reserve the capability of packet processing for each VNF. Consequently, even if the packet processing is unevenly loaded on a certain VNIC, the capabilities of VNFs can be avoided from interfering with one another. The present embodiment makes it possible to reserve the maximum capability of packet processing in a unit of a VNF and also to prevent a certain VNF from affecting the capabilities of packet processing of the remaining VNFs.

As the above, the present embodiment can configure an information processing system 10 in which VNFs having respective different capabilities of packet processing can exert their maximum capabilities of packet processing. Consequently, there can be provided an NVF service ensuring the maximum capability, not in the best-effort manner.

In addition to the above, the present embodiment can configure the NFV system 10 in which VNFs having respective different capabilities of packet processing, if operating at their maximum capabilities of packet processing, each do not affect the capabilities of packet processing of the remaining VNFs. Consequently, multitenancy can be achieved in the NFV environment, and resource independencies among tenant users can be enhanced.

Furthermore, the present embodiment establishes a mechanism of ensuring capability of packet processing of a VNF in environment wherein the packet processing is carried out in a polling scheme as the above. Even if the packet processing is unevenly loaded on a certain NIC, the technique of the present application does not affect the capabilities of packet processing of the remaining NICs and VNFs.

Here, descriptions will now be made in relation to the interface information table 211 and the interface information structure 212 with reference to FIGS. 13 and 14. FIG. 13 illustrates an example of the interface information table 211 of the present embodiment and FIG. 14 illustrates an example of the interface information structure 212 of the present embodiment.

Like the example of FIG. 12, the VNF 1 includes the two interfaces (ports) VNIC 1 and VNIC 2; the VNF 2 includes the two interfaces VNIC 3 and VNIC 4; and the VNF 3 includes the two interfaces VNIC 5 and VNIC 6.

FIGS. 13 and 14 illustrate examples of the registered contents of the interface information table 211 and the interface information structure 212, respectively, under a state where the VNF 1, the VNF 2, and the VNF 3 are assumed to have weight values of 50, 50, and 90, respectively.

In particular, FIG. 13 illustrates the contents of the interface information table 211 in which various pieces of information are registered in the above Process P13 (Step S202-S205 of FIG. 10). As illustrated in FIG. 14, the contents of the interface information structure 212 are of a format obtained by adding a field of a core ID to the interface information table 211 and are registered in the above processes P14 and P15-5 (Steps S303-306 of FIG. 10 and Step S313 of FIG. 11).

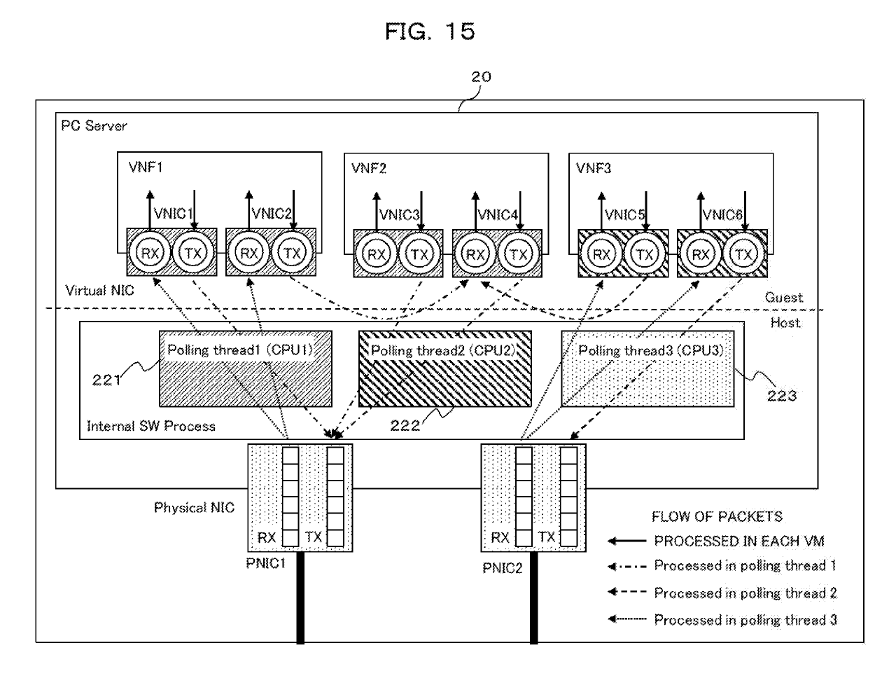

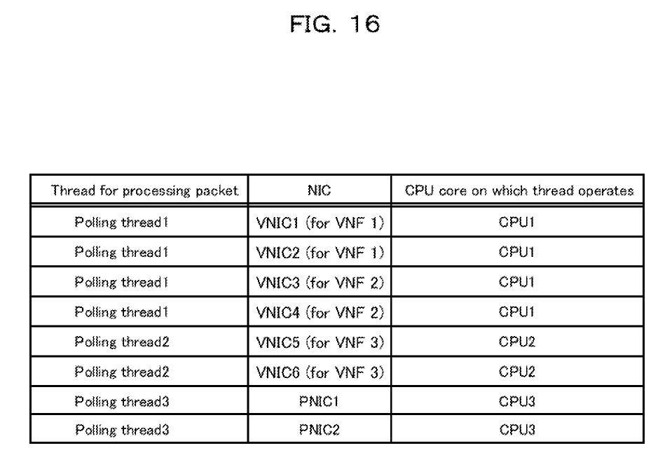

Description will now be made in relation to a case where the related technique described above with reference to FIGS. 1 and 2 applies the information processing system 10. Here, FIGS. 15 and 16 respectively correspond to FIGS. 1 and 2. FIG. 15 is a block diagram illustrating an example of the operation of the information processing system of FIG. 1 applying the technique of the present embodiment; and FIG. 16 illustrates relationship among a polling thread that carries out packet transmission and reception processing, an NIC, and a CPU core in the example of FIG. 15.

Since the related technique illustrated in FIGS. 1 and 2 randomly determines that a polling thread is in charge of a process of which port (VNIC/PNIC), the polling threads and the ports do not establish the mapping relationship in which the maximum processing capability of each VNF is not considered. In contrast to this, applying the technique of the present embodiment makes it possible to establish the mapping relationship between the polling threads and the ports in which relationship the maximum processing capability of each VNF is considered. Specifically, VNICs belonging to the same VNF are arranged so as to be processed in the same polling thread so that the capabilities of the remaining VNFs are not affected even if the processing is unevenly loaded on a certain VNIC.

Here, it is assumed that the VNF 1 includes the VNIC 1 and the VNIC 2; the VNF 2 includes the VNIC 3 and the VNIC 4; the VNF 3 includes the VNIC 5 and the VNIC 6; and the weight values of the VNF 1, the VNF 2, and the VNF 3 are 50, 50, and 90, respectively. Consequently, the technique of the present embodiment improves the mapping relationship illustrated in FIG. 1 to the mapping relationship of FIG. 15. Since the sum of the weight values of the VNF 1 and the VNF 2, both of which are 50, is 100, the VNF 1 and the VNF 2 can be processed in a single polling thread. However, since the VNF 3 has a weight value of 90, a single polling thread is unable to process both the VNF 1 and the VNF 3 or the VNF 2 and the VNF 3. As a consequence, as illustrated in FIG. 15, the polling thread 1 carries out packet transmission and reception processing of the four VNICs of the VNF 1 and the VNF 2 that specifically are the VNIC 1 to the VNIC 4, and the polling thread 2 carries out packet transmission and reception processing of the two VNICs of the VNF 3 that specifically are the VNIC 5 and the VNIC 6.

As illustrated in FIG. 2, in the related technique of FIG. 1, the packet transmission and reception processing of the VNIC 1 to the VNIC 3 is carried out in CPU 1; the packet transmission and reception processing of the VNIC 4 to the VNIC 6 is carried out in CPU 2; and the packet transmission and reception processing of the PNIC 1 to the PNIC 2 is carried out in CPU 3. In contrast to the above, in the technique of the present embodiment illustrated in FIG. 15, the packet transmission and reception processing of the VNIC 1 to the VNIC 4 is carried out in CPU 1; the packet transmission and reception processing of the VNIC 5 and the VNIC 6 is carried out in CPU 2; and the packet transmission and reception processing of the PNIC 1 to the PNIC 2 is carried out in CPU 3, as illustrated in FIG. 16.

(5) Others:

A preferable embodiment of the present invention is detailed as the above. The present invention is by no means be limited to the above embodiment and various changes and modifications can be suggested without departing from the spirit of the present invention.

For example, while the foregoing embodiment assumes that the information processing system is an NFV system that adopts a polling scheme, the present invention is not limited to this. The present invention can be applied any information processing system that virtualizes various functions to be provided, obtaining the same effects at the foregoing embodiment.

The embodiment detailed above reserves the capability of packet processing for each VNF under environment where packet processing is carried out in a polling scheme, but the present invention is by no means limited to this. The present invention is also applied to other processing except for packet processing likewise the foregoing embodiment, obtaining the same effects as the foregoing embodiment.

The processing capability can be reserved for each virtual function.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a program for causing a computer to execute a process comprising:
causing a plurality of processor cores to execute processes of a plurality of virtual functions each including one or more virtual interfaces; and
allocating the plurality of virtual functions to the plurality of processor cores in a unit of each of the plurality of virtual functions such that the one or more of the virtual interfaces included in each of the plurality of virtual functions belong to one of the plurality of processor cores.

2. The non-transitory computer-readable recording medium according to claim 1, the process further comprising allocating the plurality of virtual functions to the plurality of processor cores in a unit of each of the plurality of virtual functions within a range of a processing capability of each of the plurality of processor cores with reference to a value representing a ratio of a processing capability of each of the plurality of virtual functions to the processing capability of the processor core.

3. The non-transitory computer-readable recording medium according to claim 2, the process further comprising:
in allocating a target virtual function containing a new virtual interface to one of the plurality of processor cores,
determining whether first identification information related to the target virtual function is already registered;
obtaining, when the first identification information is already registered, second identification information related to the one processor core allocated thereto the target virtual function; and
allocating the new virtual interface of the target virtual function to the one processor core associated with the second identification information.

4. The non-transitory computer-readable recording medium according to claim 3, the process further comprising:
calculating, when the first identification information is not registered, a sum of values representing respective ratios of processing capabilities of the virtual functions allocated to each of the plurality of processor cores; and
determining a processor core that affords to be allocated the target virtual function thereto with reference to the sum calculated for each of the plurality of processor cores and the value representing the ratio of processing capability of the target virtual function to the processing capability of the processor core.

5. The non-transitory computer-readable recording medium according to claim 4, the process further comprising:
sorting the plurality of processor cores in descending order of the sums; and
determining the processor core that affords to be allocated the target virtual function thereto by comparing a value representing an idle ratio of each of the plurality of processor cores with the value representing the ratio of the processing capability of the target virtual function to the processing capability of the processor core in the order obtained in the sorting.

6. The non-transitory computer-readable recording medium according to claim 4, the process further comprising:
when not determining the processor core that affords to be allocated the target virtual function thereto,
sorting the plurality of virtual functions already allocated to the plurality of processor cores and the target virtual function in descending order of values representing ratios of processing capabilities of the plurality of virtual function and a value representing a ratio of a processing capability of the target virtual function; and
re-allocating the plurality of virtual functions and the virtual function to the plurality of processor cores in the order obtained in the sorting.

7. An information processing apparatus comprising:
a memory; and
a processor coupled to the memory and the processor configured to:
cause a plurality of processor cores to execute processes of a plurality of virtual functions each including one or more virtual interfaces; and
allocate the plurality of virtual functions to the plurality of processor cores in a unit of each of the plurality of virtual functions such that the one or more of the virtual interfaces included in each of the plurality of virtual functions belong to one of the plurality of processor cores.

8. The information processing apparatus according to claim 7, wherein the processor is further configured to allocate the plurality of virtual functions to the plurality of processor cores in a unit of each of the plurality of virtual functions within a range of a processing capability of each of the plurality of processor cores with reference to a value representing a ratio of a processing capability of each of the plurality of virtual functions to the processing capability of the processor core.

9. The information processing apparatus according to claim 8, wherein the processor is further configured to:
in allocating a target virtual function containing a new virtual interface to one of the plurality of processor cores,
determine whether first identification information related to the target virtual function is already registered;
obtain, when the first identification information is already registered, second identification information related to the one processor core allocated thereto the target virtual function; and
allocate the new virtual interface of the target virtual function to the one processor core associated with the second identification information.

10. The information processing apparatus according to claim 9, wherein the processor is further configured to:
calculate, when the first identification information is not registered, a sum of values representing respective ratios of processing capabilities of the virtual functions allocated to each of the plurality of processor cores; and
determine a processor core that affords to be allocated the target virtual function thereto with reference to the sum calculated for each of the plurality of processor cores and the value representing the ratio of processing capability of the target virtual function to the processing capability of the processor core.

11. The information processing apparatus according to claim 10, wherein the processor is further configured to:
sorting the plurality of processor cores in descending order of the sums; and
determining the processor core that affords to be allocated the target virtual function thereto by comparing a value representing an idle ratio of each of the plurality of processor cores with the value representing the ratio of the processing capability of the target virtual function to the processing capability of the processor core in the order obtained in the sorting.

12. The information processing apparatus according to claim 10, wherein the processor is further configured to:
when not determining the processor core that affords to be allocated the target virtual function thereto,
sorting the plurality of virtual functions already allocated to the plurality of processor cores and the target virtual function in descending order of values representing ratios of processing capabilities of the plurality of virtual function and a value representing a ratio of a processing capability of the target virtual function; and
re-allocating the plurality of virtual functions and the virtual function to the plurality of processor cores in the order obtained in the sorting.

13. An information processing system comprising:
an information processing apparatus; and
a terminal that accesses the information processing terminal, wherein the information processing apparatus comprises:
a memory; and
a processor coupled to the memory and the processor configured to:
cause a plurality of processor cores to execute processes of a plurality of virtual functions each including one or more virtual interfaces; and
allocate the plurality of virtual functions to the plurality of processor cores in a unit of each of the plurality of virtual functions such that the one or more of the virtual interfaces included in each of the plurality of virtual functions belong to one of the plurality of processor cores.

14. The information processing system according to claim 13, wherein the processor is further configured to allocate the plurality of virtual functions to the plurality of processor cores in a unit of each of the plurality of virtual functions within a range of a processing capability of each of the plurality of processor cores with reference to a value representing a ratio of a processing capability of each of the plurality of virtual functions to the processing capability of the processor core.

15. A method for processing information, the method comprising:
causing a plurality of processor cores to execute processes of a plurality of virtual functions each including one or more virtual interfaces; and
allocating the plurality of virtual functions to the plurality of processor cores in a unit of each of the plurality of virtual functions such that the one or more of the virtual interfaces included in each of the plurality of virtual functions belong to one of the plurality of processor cores.

16. The method according to claim 15, further comprising allocating the plurality of virtual functions to the plurality of processor cores in a unit of each of the plurality of virtual functions within a range of a processing capability of each of the plurality of processor cores with reference to a value representing a ratio of a processing capability of each of the plurality of virtual functions to the processing capability of the processor core.

17. The method according to claim 16, further comprising:
in allocating a target virtual function containing a new virtual interface to one of the plurality of processor cores,
determining whether first identification information related to the target virtual function is already registered;
obtaining, when the first identification information is already registered, second identification information related to the one processor core allocated thereto the target virtual function; and
allocating the new virtual interface of the target virtual function to the one processor core associated with the second identification information.

18. The method according to claim 17, further comprising:
calculating, when the first identification information is not registered, a sum of values representing respective ratios of processing capabilities of the virtual functions allocated to each of the plurality of processor cores; and
determining a processor core that affords to be allocated the target virtual function thereto with reference to the sum calculated for each of the plurality of processor cores and the value representing the ratio of processing capability of the target virtual function to the processing capability of the processor core.

19. The method according to claim 18, further comprising:
sorting the plurality of processor cores in descending order of the sums; and
determining the processor core that affords to be allocated the target virtual function thereto by comparing a value representing an idle ratio of each of the plurality of processor cores with the value representing the ratio of the processing capability of the target virtual function to the processing capability of the processor core in the order obtained in the sorting.

20. The method according to claim 18, further comprising:
when not determining the processor core that affords to be allocated the target virtual function thereto,
sorting the plurality of virtual functions already allocated to the plurality of processor cores and the target virtual function in descending order of values representing ratios of processing capabilities of the plurality of virtual function and a value representing a ratio of a processing capability of the target virtual function; and
re-allocating the plurality of virtual functions and the virtual function to the plurality of processor cores in the order obtained in the sorting.
